(19) United States
(12) Patent Application Publication
(10) Pub. No.: US 2005/0197456 A1
(43) Pub. Date: Sep. 8, 2005

(54) Sealing layer resin compositions

(76) Inventors: Jose Luis Nicolini, Mendoza (AR); Jose Luis Pezzutti, Mendoza (AR); Ralph-Dieter Maier, Mason, OH (US); Vassilios Galiatsatos, Lebanon, OH (US); Werner Schoene, Schriesheim (DE)

Correspondence Address: DILWORTH & BARRESE, LLP, 333 EARLE OVINGTON BLVD., UNIONDALE, NY, 11553, US

(21) Appl. No.: 11/020,845

(22) Filed: Dec. 23, 2004

Related U.S. Application Data
(60) Provisional application No. 60/532,741, filed on Dec. 24, 2003.

(51) Int. Cl. C08F 8/00

(52) U.S. Cl. 525/191

(57) ABSTRACT

A polypropylene resin composition includes a random copolymer of propylene, at least one C₄-C₁₀ α-olefin, and ethylene, wherein the ratio of the weight percentage of ethylene in the polypropylene random copolymer relative to the sum of the weight percentages of the C₄-C₁₀ α-olefins is less than or equal to 1, and, from 10 to 20,000 ppm of at least one nucleating agent.

### CROSS-REFERENCE TO RELATED APPLICATIONS

The present application claims priority to U.S. provisional application Ser. No. 60/532,741 filed Dec. 24, 2003, which is herein incorporated by reference.

### BACKGROUND 1. Field of the Invention

The present invention relates to films made from polypropylene resin compositions which have a desirably large difference between seal initiation temperature (“SIT”) and melting point (“Tm”). Such films are particularly desirable as sealing layer resins due to their improved processability. 2. Background of the Art

Polypropylene (“PP”) films are widely used as packaging materials, especially for food. Coating, laminating or coextruding a substrate film with a film made of a heat-sealable resin yields a heat sealable film. Materials traditionally used in heat sealing applications are isotactic random copolymers of propylene with at least one more C₂-C₂₀-α-olefin other than propylene, made by using Ziegler/Natta based (“ZN”) catalysts. In order to simplify the description, random copolymers of propylene and ethylene will be referred to as C₃/C₂ random copolymers, random copolymers of propylene and 1-butene will be referred to as C₃/C₄ random copolymers, and random copolymers of propylene, ethylene and 1-butene will be referred to as C₃/C₂/C₄ random copolymers.

Random copolymers of propylene and one second higher α-olefin other than ethylene will be referred to as C₃/Cₓ-C_{y} random copolymers where x indicates the minimum amount of carbon atoms said second higher α-olefin can be comprised of, and y indicates the maximum amount of carbon atoms said second higher α-olefin can be comprised of. For example, the term C₃/C₄-C₈ random copolymers comprises C₃/C₄ random copolymers, C₃/C₅ random copolymers, C₃/C₆ random copolymers, C₃/C₇ random copolymers and C₃/C₈ random copolymers. Random copolymers of propylene, ethylene and one third higher α-olefin will be referred to as C₃/C₂/Cₓ-C_{y} random copolymers where x indicates the minimum amount of carbon atoms said third higher α-olefin can be comprised of, and y indicates the maximum amount of carbon atoms said third higher α-olefin can be comprised of. For example, the term C₃/C₂/C₄-C₆ random copolymers comprises C₃/C₂/C₄ random copolymers, C₃/C₂/C₅ random copolymers and C₃/C₂/C₆ random copolymers.

Polypropylene random copolymers are being used for heat-sealing applications. Typically, they are applied in multi-layer cast or biaxially oriented films as the outer layer(s).

There are three major properties that make up the overall performance profile of a sealing layer grade. First, the seal initiation temperature (SIT) should be as low as possible to allow the heat sealing process to take place at as low as possible temperature, such that cost savings can be made by running film packaging machinery at higher speed and with less energy consumption. Besides that it is necessary, e.g., for overwraps, to keep packed goods maximally unaffected by applying as low as possible sealing temperatures for the overwrap.

Second, the level of xylene solubles and/or hexane extractables should be kept as low as possible to prevent migration of these components into food and to fulfill the various national and international regulations for food contact applications.

Third, in order to improve processability in machine direction orientation (MDO), stretching on oriented polypropylene (OPP) stenter frame lines, especially to enable higher line speeds, higher stretching roller temperatures are required. This can only be verified if the melting temperature of the sealing layer material is as high as possible in order to prevent sticking on the MDO stretching rollers.

A common problem in the art is obtaining polypropylene resin films with desirably low SIT while also obtaining a desirably high melting point and desirably low levels of xylene solubles and/or hexane extractables. It is generally known that polypropylene resin compositions with desirably low SIT typically have undesirably low melting temperatures and undesirably high levels of extractables. Although some success has been made in obtaining films with low SIT and elevated melting point by using polypropylene compositions produced in production processes having multiple stages (e.g., as reactor blends), such production processes are costly and prone to reactor fouling. The present invention provides an advantageous one polymerization stage capable of producing films with desirably low SIT while also having desirably high melting point and desirably low levels of xylene solubles and/or hexane extractables.

It is well known that a low SIT and low levels of extractables are typically mutually exclusive properties in polypropylene random copolymers made by using Ziegler-Natta catalysts. It is also generally well known that a low SIT and a high melting point are typically mutually exclusive properties in propylene random copolymers made by using Ziegler-Natta and metallocene catalysts.

Blending a polypropylene random copolymer with a relatively high melting point and relatively high degree of crystallinity and a polypropylene random copolymer with a relatively low melting point and a relatively low degree of crystallinity can overcome one of the two problems. Typically, a composition exhibiting a low SIT and a high melting point results. There are numerous examples for this concept. EP 263,718-B1 relates to low-crystalline propylene random copolymer compositions comprising blends of C₃/C₂/C₄-C₂₀ and C₃/C₄-C₂₀ copolymers. EP 483,523-B1 relates to compositions based on crystalline propylene copolymers comprising blends of C₃/C₄-C₈ and C₃/C₂/C₄-C₈ random copolymers or blends of C₃/C₄-C₈ and C₃/C₂ random copolymers. EP 560,326-B1 relates to semicrystalline polyolefin compositions comprising blends of C₃/C₄-C₁₀ and C₃/C₄-C₁₀ random copolymers. EP 674,991-B1 relates to crystalline propylene polymer compositions comprising C₃/C₂ and C₃/C₂/C₄-C₈ random copolymers. EP 780,432-B1 relates to compositions based on propylene polymers comprising blends of C₃/C₂/C₄ and C₃/C₂/C₄ random copolymers or blends of C₃/C₄ and C₃/C₂/C₄ random copolymers. WO 00/11076 relates to crystalline propylene copolymer compositions comprising blends of C₃/C₂ or C₃/C₄-C₈ or C₃/C₂/C₄-C₈ random copolymers with C₃/C₄-C₈ or C₃/C₂/C₄-C₈ random copolymers. WO 02/68531 relates to compositions based on random propylene copolymers, comprising blends of C₃/C₄ or C₃/C₂/C₄ random copolymers with C₃/C₄ or C₃/C₂/C₄ random copolymers. EP 1 270 651-A1 relates to polymer films comprising propylene random copolymers with the comonomer being ethylene or an α-olefin having at least four carbon atoms. WO 03/029346 relates to propylene polymer based compounds comprising blends of C₃/C₄ or C₃/C₂/C₄ random copolymers with C₃/C₄ or C₃/C₂/C₄ random copolymers. WO 03/31514 relates to crystalline propylene copolymer compositions comprising blends of C₃/C₄-C₈ random copolymers with C₃/C₄-C₈ or C₃/C₂/C₄-C₈ random copolymers. All of the sealing layer compositions disclosed in the listed patents or patent applications in this paragraph have a more or less large spread between Tm and SIT in common. Typically, they aim at low SIT and very low SIT applications. However, the low SITs are obtained at the expense of relatively large levels of xylene solubles and/or hexane extractables which are too high for certain food applications. Moreover, the effect can only be achieved by blending materials made in different polymerization steps/reactors or by producing two- or more-component compositions by using two- or multi-stage polymerization processes, such as the process discribed in the quoted patents and in [P. Giusti, L. Lazzeri, N. Barbani, L. Lelli, S. DePetris, M. G. Cascone, Macromol. Symp. 78, 285-297 (1994)]. Those two-stage processes are technically demanding and more expensive compared to one-stage polymerization processes.

In contrast to the mentioned sealing layer compositions comprising two random copolymers with pronounced differences in Tm and/or degree of crystallinity, two-component polypropylene-based sealing layer compositions are known where the two components exhibit only relatively small or no differences in Tm and/or degree of crystallinity, such as those disclosed in WO98/58971 which relates to film-making C₃/C₂/C₄-C₈ random copolymers. Also, compositions are known which have been produced by using only one polymerization stage, thus comprising only one random copolymer component, such as those disclosed in EP 881,239-B1 which relates to C₃/C₂/C₄ random copolymers. Such random copolymers exhibit low levels of extractables and low SITs, but the spread between Tm and SIT is not broad enough to provide a broad enough processing window and a low SIT at the same time.

While the vast majority of sealing layer compositions is based on ZN catalysts, some compositions have been described that are based on metallocene catalysts. In order to simplify the description, the terms “produced by using metallocene catalysts” or “based on metallocene catalysts” will in the following be represented by the term “metallocene based”. For a good metallocene based sealing layer composition, the same principles apply as for a ZN based composition: the mutual exclusive requirements of low SIT and large amounts of unmelted material at high temperatures can only be optimized by producing blends of two or more random copolymers. It is known in the art that metallocene based copolymers contain lower levels of solubles than their ZN based analogs. Nontheless, the introduction of amorphous fractions, that afford high levels of xylene solubles/hexane extractables, into state-of-the-art metallocene based sealing layer compositions comprised of two or more components has been inevitable. Thus the level of xylene solubles/hexane extractables is still too high with regard to cetain food packaging applications.

In US application 2002/0176974-A1, heat-seal polymer films are disclosed comprising a layer of film formed from a metallocene based isotactic C₃/C₂ random copolymer. Typical for films made from single component metallocene random copolymers, the films exhibit very low levels of solubles/extractables, but the spread between Tm and SIT os not very broad, with the consequence that the processability window is relatively narrow.

In EP 982,328-B1, polypropylene resin compositions are disclosed comprising a polypropylene component and a C₃/C₂ random copolymer component. The main purpose of those compositions is their use as sealants in a broader sense, for example as heat-seal improving agents. However, they are unsuitable for acting as a stand-alone sealing-layer (as part of a bi- or multi-layer cast film or biaxially oriented film) because of their high MFR. Furthermore, such compositions contain from 50 to 99 wt % of the C₃/C₂ random copolymers. This limits large-scale production of such compositions to specialty processes as described above or in EP 982 328-B1.

WO04/101673-A2 discloses polypropylene resin compositions comprising blends of C₃/C₂/C₄-C₂₀ or C₃/C₂ or C₃/C₄-C₂₀ random copolymers and C₃/C₂/C₄-C₂₀ or C₃/C₂ or C₃/C₄-C₂₀ random copolymers. Typical for the sealing layer compositions disclosed in this group is the very low SIT and very low levels of solubles/extractables, but the processability of such resin compositions would benefit from a broader spread between Tm and SIT.

Summarizing the state-of-the-art of two component sealing layer compositions, all of the sealing layer compositions comprising at least two random copolymer components accomplished a broadening of the processability window, i. e. the spread between Tm and SIT by blending high Tm and low Tm components. In the cases where extreme spreads were realized, the levels of solubles/extractables were too high. In cases where the levels of solubles/extractables were very low, there still are some limitations with regard to the breadth of the spread.

The state-of-the-art of sealing layer compositions comprising only one random copolymer component or two random copolymer components with only small differences in Tm and degree of crystallinity is summarized in that the spread between Tm and SIT is generally lower than in the above discussed compositions comprising two random copolymer components with large deifferences in Tm and degree of crystallinity, whereas the level of extractables/solubles generally is satisfactory low.

The concept of adding nucleating agents to sealing layer compositions is relatively new. U.S. Pat. No. 6,270,911 discloses that the use of nucleating agents in preparing random copolymers leads to higher crystallization temperatures, thereby increasing crystallization. The ratio of the weight percentages of 1-butene to ethylene in the polypropylene random copolymers disclosed in said patent is low and the melting points of the nucleated random copolymers are not higher than the melting point of their non-nucleated analogs. Also, the processing window expressed as the difference between melting point and SIT is much narrower than in the present invention.

EP 945,490-B1 discloses compositions comprising propylene/ethylene random copolymers, nucleating agents and anti-blocking agents. The compositions of this patent aim at stretched films and provide various advantages in film properties and processing. However, the compositions do not focus on low SIT and low level of extractables. The effect of an increase in the melting point upon addition of a nucleating agent is not observed.

U.S. Pat. No. 6,562,886 discloses compositions comprising a propylene-based polymer and a nucleating agent that are well-balanced in toughness and heat-sealability, and are not sticky, and, in addition, have excellent anti-blocking properties. Heat sealability is improved through a lowering of the SIT by adding a nucleating agent. The compositions disclosed in that patent are produced using metallocene catalysts. The melting point of these metallocene-based polypropylene random copolymers is not increased by adding nucleating agents.

An objective of the invention is to eliminate the disadvantages of the state-of-the-art and make polypropylene resin compositions available that are suited for heat-sealing applications and that have, at very low levels of solubles/extractables, a broader spread between Tm and SIT than state-of-the-art polypropylene compositions or that have, at very low levels of solubles/extractables and low SITs, higher melting points than state-of-the-art polypropylene compositions.

The objective of the invention is accomplished by compositions comprising certain random copolymers of propylene, ethylene and 1-butene, and nucleating agents, with the C₃/C₂/C₄ random copolymers being characterized in that a maximum ratio of ethylene to 1-butene content is not exceeded. It was surprisingly found that in such compositions, the addition of a nucleating agent to a random copolymer leads to an increased melting point, without affecting the SIT. The objective of the invention is also accomplished by providing a process for the preparation the polypropylene compositions.

### SUMMARY

A polypropylene resin composition is provided herein. The composition comprises a random copolymer of propylene, at least one C₄-C₁₀ α-olefin, and ethylene, wherein the ratio of the weight percentage of ethylene in the polypropylene random copolymer relative to the sum of the weight percentages of the C₄-C₁₀ α-olefins is less than or equal to 1, and, from 10 to 20,000 ppm of at least one nucleating agent.

### DETAILED DESCRIPTION OF PREFERRED EMBODIMENT(S)

The present invention relates to compositions comprising a random copolymer of propylene with at least one C₄-C₁₀-α-olefin, and ethylene, and one or more nucleating agent(s). In compounds with the random copolymers of the present invention, a nucleating agent increases the melting point of the film. During the formation process of a biaxially oriented film, this allows the solid film in the machine direction orientation (“MDO”) to be preheated at higher temperatures. Thus, film stretching is facilitated and processability is improved. Sealing-layer compositions are provided with very low levels of extractables, low SITs and high melting points. They are obtained from a process comprising at least one polymerization step using at least one polymerization reactor and at least one compounding step where at least one nucleating agent is added. Preferred is a process comprising one polymerization step using one polymerization reactor, and one compounding step where at least one nucleating agent is added. Compared to the prior art disclosed in EP 881,239-B1 and WO98/58971, the melting points of the compositions of the present invention are significantly higher at unchanged SITs and levels of extractables. It was found that the addition of certain nucleating agents to certain random copolymers of propylene, ethylene and 1-butene, with the C₃/C₂/C₄ random copolymers being characterized in that a maximum ratio of ethylene to 1-butene is not exceeded, unexpectedly increases the melting point of the compositions without affecting the SIT. Thus, in biaxially oriented polypropylene (“BOPP”) film formation processes, the solid film layer can be preheated at higher temperatures and thus film stretching is greatly facilitated and higher line speeds can be achieved.

The invention will preferentially cover easy sealing coextruded oriented polypropylene (“OPP”) film. The main advantages being a wide processing window for MDO stretching in the stenter frame OPP process, allowing higher MDO stretching temperatures and thus higher line speeds, together with a low seal initiation temperature allowing high machine speeds on film packaging lines.

Sealing layers using the invented new material provide higher crystallinity, clarity and stiffness.

Besides OPP-film, the invention is advantageous for all other applications with good heat-sealing requirements e.g., cast film, tubular film (air cooled or water quenched), extrusion coating, sheet for thermoforming.

More particularly, polypropylene resin compositions are provided which are particularly suited for heat seal applications. The compositions comprise combinations of a random copolymer of propylene with one or more C₄-C₁₀-α-olefin and ethylene, and at least one nucleating agent. A process for the production of polypropylene resin compositions is also provided, comprising (a) a polymerization step where propylene, at least one C₄-C₁₀-α-olefin, and ethylene, are copolymerized in the absence of a liquid reaction medium from the gas-phase at a temperature from 20° C. to 150° C. and a pressure from 1 to 100 bar in the presence of a Ziegler/Natta catalyst system maintaining copolymerization at said conditions, and optionally hydrogen, to provide a polypropylene random copolymer, and (b) the addition of at least one nucleating agent to the polypropylene random copolymer.

The present invention provides a polypropylene resin composition that has a high melting point, a low SIT and very low levels of extractables. A resin composition exhibiting a combination of all of these three properties is unaccomplished in the prior art. The resin composition comprises a polypropylene random copolymer component with at least one C₄-C₁₀-α-olefin and ethylene. The ratio of the weight percentage of ethylene in the composition relative to the sum of the weight percentages of the C₄-C₁₀-α-olefins must be less than or equal to 1. Preferred α-olefins other than propylene are 1-butene, 1-pentene, 1-hexene, 4-methyl-1-pentene and 1-octene. Particularly preferred is 1-butene. The propylene random copolymer can be comprised of one or more polypropylene random copolymer components. For example, the propylene random copolymer can be comprised of a first propylene random copolymer component and a second polypropylene random copolymer component which is different from the first polypropylene random copolymer component. Preferably, the propylene random copolymer is comprised solely by one polypropylene random copolymer component. The resin composition of the present invention comprises furthermore at least one nucleating agent. Nucleating agents are usually incorporated into the polymer during pelletization of the polymerization product produced in pulverulent form. Examples of suitable nucleating agents are inorganic additives, such as talc, silica or kaolin, salts of mono- or polycarboxylic acids, such as sodium benzoate, aluminum tert-butylbenzoate or disodium norbornanedicarboxylate, dibenzylidene sorbitol or its C₁-C₈-alkyl- or alkoxy- or halogeno-substituted derivatives, such as bis(p-methylbenzylidene)sorbitol or bis(3,4-dimethylbenzylidene)sorbitol, salts of diesters of phosphoric acid, such as sodium 2,2 ′-methylenebis(4,6-ditert-butylphenyl)phosphate, amides of dicarboxylic acids, such as N,N′-dicyclohexylnaphthalinedicarboxamide, and rosin based nucleating agents. The content of nucleating agents in the polypropylene resin composition is generally up to 2% by weight. Nucleating agents of this type are generally commercially available and are described, for example, in Zweifel (Ed.), Plastics Additives Handbook, 5th Edition, Hanser Publishers, Munich, 2000, Chapter 18.

In addition to the nucleating agent, which is one key component in the present invention, it is usual for customary amounts of conventional additives, such as stabilizers, lubricants, mold-release agents, fillers, antistats, plasticizers, dyes, pigments or flame retardants to be added to the polypropylene composition prior to its use. These are usually incorporated into the polymer during pelletization of the polymerization product produced in pulverulent form. The usual stabilizers are antioxidants, such as sterically hindered phenols, process stabilizers, such as phosphites or phosphonites, acid scavengers, such as calcium stearate, zinc stearate or dihydrotalcite, sterically hindered amines, or else UV stabilizers. The novel polypropylene composition generally comprises amounts of up to 2% by weight of one or more of the stabilizers. Examples of suitable lubricants and mold-release agents are fatty acids, the calcium or zinc salts of the fatty acids, fatty amides and low-molecular-weight polyolefin waxes, and these are usually used in concentrations of up to 2% by weight. Additives of this type are generally commercially available and are described, for example, in Zweifel (Ed.), Plastics Additives Handbook, 5th Edition, Hanser Publishers, Munich, 2000.

For the purposes of the present invention, the term “polymerizaton” refers to both homopolymerizations and copolymerizations. The constituents of the polypropylene composition of the present invention, or the entire polypropylene composition, may be prepared by polymerizing propylene, at least one more C₄-C₁₀-α-olefins, and ethylene, in the presence of a suitable catalyst system. Optionally, hydrogen can be used as a means to regulate molecular weight and/or to increase polymerization activity.

The polymerization is generally carried out at temperatures of from 20 to 150° C. and at pressures of from 1 to 100 bar, with average residence times of from 0.5 to 5 hours, preferably at temperatures of from 60 to 90° C. and at pressures of from 20 to 50 bar, with average residence times of from 0.5 to 3 hours. The polymerization is carried out in a known manner in bulk, in suspension or in the gas phase, in reactors usually used for polymerizing propylene. The polymerization can be carried out batchwise or, preferably, continuously. The polymerization can be carried out in one or more stages. Preferably, the polymerization is carried out in one stage, thus delivering a polymer composition comprising one polypropylene random copolymer component. More preferably, this one-stage polymerization is carried out in the gas-phase.

In case the random copolymer composition is comprised of two random copolymer components, it is possible to polymerize two or more starting polymers separately, then to mix these by using suitable mixing equipment, such as screw extruders or diskpack plasticators, kneaders or roll mills. However, it is preferable for such propylene polymer compositions not to be polymerized separately. One preferred method for the production of two-component random copolymer compositions is to carry out polymerization in the presence of a suitable catalyst in a series of different reactors, for example in a reactor cascade with at least two different reactors, with conditions in the reactors sufficiently different to give the final composition desired. Particularly preferred is a process that uses a reactor cascade of two reactors, wherein the polymerizations in both reactors are carried out in the gas phase.

The polymerizations are carried out in the presence of stereospecific Ziegler/Natta catalyst. An essential component of a Ziegler/Natta catalyst is a solid catalytic component comprising a titanium compound having at least one titanium-halogen bond and a compound of magnesium containing at least one halogen, both supported on a magnesium halide in active form. Non-limiting examples for such solid catalytic components are described in U.S. Pat. No. 4,399,054, EP 45,977, U.S. Pat. No. 4,784,983, U.S. Pat. No. 4,861,847, and U.S. Pat. No. 6,376,417. Optionally, these components are supported on a porous particulate support, such as silica, alumina, etc. Non-limiting examples for such supported solid catalytic components are described in EP 288,845, EP 864,591, U.S. Pat. No. 5,006,620, U.S. Pat. No. 5,162,465, and US 2004/0033887 A1, all of which are herein incorporated by reference. Also optionally, an internal electron donor is present. Non-limiting examples for internal donors are compounds selected from the group consisting of ethers, ketones, lactones, compounds containing N, P and/or S atoms, and esters of mono- and dicarboxylic acids. Other suitable internal donors are 1,3-diethers as discribed in EP 361,493 and EP 728,769. Another essential component (co-catalyst) is an organoaluminum compound, such as an aluminum alkyl compound. An external donor is optionally added. Non-limiting examples for external donors are described in U.S. Pat. No. 4,829,038, U.S. Pat. No. 4,990,479, U.S. Pat. No. 5,438,110, U.S. Pat. No. 5,773,537 and U.S. Pat. No. 6,469,112, all of which are herein incorporated by reference. The catalysts generally used in the process of the invention are capable of producing polypropylene with an isotactic index greater than 90%, preferably greater than 95%.

The following methods were used to characterize the pellet and film samples.

The level of xylene solubles (XS) was determined in accordance with the following method:

5 Grams of polymer are placed in 500 ml of distilled xylene (isomer mixture) which is heated beforehand to 100° C. The mixture is subsequently heated to the boiling point of xylene and held at this temperature for 60 minutes. It is subsequently cooled to 5° C. for a period of 20 min using a cooling bath and then rewarmed to 20° C. This temperature is held for 30 minutes, after which the precipitated polymer is filtered off. Then, 100 ml of filtrate are measured out exactly and the solvent is removed on a rotary evaporator. The residue is dried for 2 hours at 80° C./200 torr and weighed after cooling.

The level of xylene-soluble material is given by the following formula:
XS=(g·500·100)/(G·V)
wherein:

XS=level of xylene-soluble material in % by weight

g=amount found

G=amount of product weighed out

V=volume of filtrate used.

The level of hexane extractables (HE) were determined according to the FDA 21 CFR 177.1520 procedure at 50° C. and 2 h extraction time. NMR: ¹³C-NMR measurements were performed in order to determine the ethylene and 1-butene content of the random copolymers. The frequency was 75 MHz and the solvent deuterated trichlorobenzene. Alternatively, IR spectroscopy can be used to determine the ethylene and 1-butene contents, as well.

DSC measurements were carried out on the pellets and on cast films. The typical sample size was 6 mg. A sample was heated from 30° C. to 200° C. at 20° C./minute (1^{st} heating run), and held at this temperature for 3 minutes. Then the sample was cooled down to 30° C. at 10° C./minute and held at that temperature for another 3 minutes. Then it was heated up again to 200° C. at 10° C./minute (2^{nd} heating run). From the endothermic curves obtained, the highest peak was read and indicated as melting point (hereinafter abbreviated as Tm). For the pellets, melting points were determined from the 2^{nd} heating run (hereinafter abbreviated as Tmp). For the films, melting points were determined from the 1^{st} heating run (hereinafter abbreviated as Tmf).

Regarding the seal initiation temperature (SIT), temperature dependent seal strengths of the cast films were determined using a Kopp SGPE20 sealing machine, equipped with flat Teflon® coated sealing bars with the dimensions 10×100 mm. The sealing bars were both heated to the same temperature. The specific conditions are as follows:
Specimen width: 45 mm
Specimen pressure: 0.33 N/mm²
Sealing Force: 150 N (Sealing Area: 10×45 mm²)
Sealing time: 1 s
Delay time: 60 s
Tearing speed: 2.5 m/min
Sealing force to determine SIT: 15N/45 mm (by interpolation)
Ambient temperature: 23° C.

The spread between the SIT and Tmf of the films is expressed as the SMS parameter. The larger the SMS parameter, the larger the spread between SIT and Tmf, the more pronounced the effect of the invention. The SMS parameter is calculated according to the following formula:
SMS=100%*(Tmf−SIT)/SIT

The following Examples 1, 2, 3 and Application Example 1 exemplify, but do not limit the invention. Comparative Examples 1, 2, 3, and Comparative Application Example 1 are presented for comparison purposes and do not exemplify the invention.

### EXAMPLE 1

1. Preparation of Ti-Containing Solid (in Connection with the Synthesis of a Ziegler-Natta Catalyst).

To a suspension of 57 kg of silica gel (Sylopol® 2229 by Grace Davison) in a mixture of 342 L ethylbenzene and 171 L heptane were added 542 L of a 20 wt % solution of n-butyl-n-octylmagnesium in heptane at ambient temperature. The reaction mixture was stirred at 95° C. for 30 min and subsequently cooled to 20° C., after which 55.5 kg of gaseous hydrogen chloride were introduced. After 120 min, the reaction product was admixed with 54.6 kg ethanol while stirring continuously. After 30 min of stirring, 536 kg of titaniumtetrachloride and 122 kg of dibutyl phthalate were added and stirred at 100° C. for 60 min. The solid thus obtained was filtered off and washed a number of times with ethylbenzene. The solid product obtained in this way was extracted for 180 min at 125° C. with a 10% strength by volume solution of titanium tetrachloride in ethylbenzene. The solid product was then separated from the extractant by filtration and washed with heptane until the washings contained only 0.3% by weight of titanium tetrachloride.

The titanium-containing solid component contained 4.2% by weight of Ti, 8.5% by weight of Mg, and 33.0% by weight of Cl.

2. Production of Propylene-ethylene-1-butene Copolymer Composition.

This exemplifies the production of the random copolymer component of the polypropylene resin composition according to the invention.

Polymerization:

The polymerization of a propylene-ethylene-1-butene random copolymer was carried out in the presence of a Ziegler-Natta catalyst, with cyclohexyl-methyl-dimethoxy-silane as the external donor, in a vertically stirred gas-phase reactor having a volume of 25 m³, using hydrogen as molecular weight regulator, at a temperature of 70° C. and a residence time of 80 minutes. A mixture of propylene, ethylene and 1-butene was introduced into the reactor. The reaction conditions included an ethylene partial pressure of 0.5 bar, a butene partial pressure of 2.5 bar and a total pressure of 19 bar. The flow rate of triethylaluminum into the reactor was 10 gram-mol/h. A polymer powder was obtained.

Extrusion and Pelletization:

This exemplifies the compounding step of the production of the polypropylene resin composition according to the invention.

The melt flow rate (at 230° C. and 2.16 kg, ISO 1133) of the powder obtained was 1.0 g/10 minutes. 500 Ppm of tetrakis-(methylene-(3,5-di-tertbutyl)-4-hydrocinnamate)methane (Irganox 1010 by Ciba SC), and 1000 ppm of tris-(2,4-di-tert-butylphenyl)phospite (Irgafos 168 by Ciba SC) were added as stabilizers. 1000 ppm of sodium benzoate nucleating agent were added to the powder. The product was then visbroken during the extrusion in the presence of peroxide up to a melt flow rate of 6 g/10 minutes. The product was obtained in the form of pellets. The properties of the pellets are listed in Table 1 below.

Production of Films:

Cast films were produced using a Fourne Bonn extruder. The length of the screw was 720 mm, the L/D ratio was 24 and the screw speed was 55 rpm. The mass temperature was 220° C. The die width was 450 mm; the die thickness was 0.6 mm. The chill roll temperature was 20° C. The line speed was 5 m/min. The thickness of the produced films was 50 μm. The properties of the films are listed in Table 2.

### EXAMPLE 2

Production of Propylene-ethylene-1-butene copolymer composition.

The preparation of the Ti containing solid was performed in accordance with the procedure set forth above in Example 1.

Polymerization:

The polymerization was performed in accordance with the procedure set forth above in Example 1.

Extrusion and Pelletization:

Extrusion and pelletization were performed as in Example 1 except that instead of 1000 ppm sodium benzoate, 1000 ppm of an aluminum hydroxy-bis[2,2′-methylenebis[4,6-di(tert-butyl)phenyl]phosphate] blend (ADK-Stab NA-21 by Asahi Denka Kogyo) were added as the nucleating agent. The properties of the pellets are listed in Table 1.

Production of Films:

The production of polymer films was performed in accordance with the procedures set forth above in Example 1. The properties of the film are listed in Table 2.

### EXAMPLE 3

Production of Propylene-ethylene-1-butene copolymer composition.

The preparation of the Ti containing solid was performed in accordance with the procedure set forth above in Example 1.

Polymerization:

The polymerization was performed in accordance with the procedure set forth above in Example 1.

Extrusion and Pelletization:

Extrusion and pelletization were performed as in Example 1 except that instead of 1000 ppm sodium benzoate, 1000 ppm of bicyclo[2.2.1]heptane-2,3-dicarboxylic acid, disodium salt (Hyperform HPN-68 by Milliken Chemical) were added as the nucleating agent. The properties of the pellets are listed in Table 1.

Production of Films:

The production of polymer films was performed in accordance with the procedures set forth above in Example 1. The properties of the film are listed in Table 2.

### COMPARATIVE EXAMPLE 1

This comparative example illustrates the production of propylene-ethylene-1-butene copolymer composition but does not exemplify the invention. The preparation of the Ti containing solid was performed in accordance with the procedure set forth above in Example 1. Polymerization was performed in accordance with the procedures set forth above in Example 1.

Extrusion and pelletization were performed in accordance with the procedures as set forth above in Example 1 except that no nucleating agent was added. The properties of the pellets are listed in Table 1.

The production of films was performed in accordance with the procedures as set forth above in Example 1. The properties of the film are listed in Table 2.

### COMPARATIVE EXAMPLE 2

This example illustrates the polymerization of polymer components to prepare a composition which is not in accordance with the present invention.

The preparation of the Ti containing solid was performed in accordance with the procedure set forth above in Example 1.

The production of propylene-ethylene-1-butene copolymer composition was performed in accordance with the following procedure:

A 5 L autoclave was purged three times with nitrogen. The stirrer was adjusted to 175 rpm. At room temperature, 0.3 g of hydrogen, 32.5 g of ethylene and 135 g of 1-butene were added. A mixture of 15 cm³ of a solution of triethylaluminum in n-heptane (25 wt %) and of 5 cm³ of a solution of cyclohexyl methyl dimethoxysilane (0.1 M in n-heptane) were flushed into the autoclave with 1000 g of propylene and stirred for 1 min at 175 rpm. Then, 30 mg of catalyst (i.e., the titanium containing solid) of Example 1 were flushed in with more propylene, yielding a total monomer feed (propylene+ethylene+1-butene) to the reactor of 2000 g. Within 5 minutes, the temperature of the monomers mixture was brought to the polymerization temperature of 65° C. Polymerization was carried out for 15 minutes. The polymerization was ceased by degassing. 500 Grams of polymer were obtained. The polymer was removed from the autoclave and dried overnight at room temperature and atmospheric pressure. The whole procedure was repeated 6 times until a total of 3.0 kg of polymer were produced.

Extrusion and Pelletization:

500 ppm of tetrakis-(methylene-(3,5-di-tertbutyl)-4-hydrocinnamate) methane (Irganox 1010 by Ciba SC), and 1000 ppm of tris-(2,4-di-tert-butylphenyl) phospite (Irgafos 168 by Ciba SC) were added as stabilizers to the powder. The product was extruded and obtained in the form of pellets. The melt flow rate (at 230° C. and 2.16 kg, ISO 1133) of the pellets obtained was 4.0 g/10 minutes. More properties of the pellets are listed in Table 1.

Production of Films:

Cast films were produced using an Optical Control Systems ME extruder. The length of the screw was 520 mm, the L/D ratio was 24 and the screw speed was 50 rpm. The mass temperature was 230° C. The die width was 150 mm, the die thickness was 0.5 mm. The chill roll temperature was 20° C. The line speed was 3.5 m/min. The thickness of the produced films was 50 μm.

### COMPARATIVE EXAMPLE 3

The preparation of the Ti containing solid was performed in accordance with the procedures set forth above in Example 1.

Production of propylene-ethylene-1-butene copolymer composition was performed in accordance with the procedures as set forth above in Comparative Example 2.

Extrusion and pelletization were performed in accordance with the procedures as set forth above in Comparative Example 2. In addition, 1000 ppm of sodium benzoate nucleating agent were added.

The production of films was performed in accordance with the procedures as set forth above in Comparative Example 2.

TABLE 1
Properties of pellets
ΔTmp is the difference between Tm of nucleated pellets and non-nucleated pellets)

| | | | | Comp. | Comp. | Comp |
|---|---|---|---|---|---|---|
| | Example 1 | Example 2 | Example 3 | Example 1 | Example 2 | Example 3 |
| C2 | 1.9 | 1.9 | 1.9 | 1.9 | 4.5 | 4.5 |
| content | | | | | | |
| [wt %] | | | | | | |
| C4 | 7.2 | 7.2 | 7.2 | 7.2 | 2.4 | 2.4 |
| content | | | | | | |
| [wt %] | | | | | | |
| Tmp [° C.] | 134.4 | 134.4 | 134.4 | 129.4 | 135.7 | 136.5 |
| ΔTmp [° C.] | 5.0 | 5.0 | 5.0 | — | — | 0.8 |
| XS [wt %] | 6.7 | 6.6 | 6.6 | 6.5 | 11.3 | 11.2 |
| HE [wt %] | 1.9 | 2.0 | 2.0 | 1.9 | 4.4 | 4.4 |

TABLE 2
Properties of the films
ΔTmf is the difference between Tm of nucleated films and non-nucleated films)

| | | | | Comp. | Comp. | Comp. |
|---|---|---|---|---|---|---|
| | Example 1 | Example 2 | Example 3 | Example 1 | Example 2 | Example 3 |
| Tmf [° C.] | 130.7 | 129.3 | 128.7 | 126.7 | 134.5 | 134.4 |
| ΔTmf [° C.] | 4.0 | 2.6 | 2.0 | — | — | −0.1 |
| SIT [° C.] | 102.4 | 103.0 | 102.1 | 102.1 | 108.4 | 109.0 |
| SMS [%] | 27.6 | 25.5 | 26.1 | 24.1 | 24.1 | 23.3 |

### APPLICATION EXAMPLE 1

This example is in accordance with the present invention.

The pellets as produced in Example 2 were processed in BOPP lines under two different conditions. The first condition produces films with thicknesses of 20 μm whereas the second condition produces films with thicknesses of 50 μm. The application related data can be seen in Table 3.

### COMPARATIVE APPLICATION EXAMPLE 1

This example is not in accordance with the invention.

The same conditions were applied as in Application Example 1. However, instead of the pellets of Example 2, the pellets of Comparative Example 1 were used. The application related data can be seen in Table 3.

TABLE 3
Application related data of nucleated films
in comparison with non-nucleated films

| | |
|---|---|
| Application | Comparative Application |
| Example 1 | Example 1 |

| | | | | |
|---|---|---|---|---|
| Film Thickness | 20 | 50 | 20 | 50 |
| [μm] | | | | |
| Temperature | 123 | 130 | 123 | 130 |
| MDO [° C.] | | | | |
| Processability | good | good | good | bad (stickiness) |
| Film Quality | good | good | good | bad (white |
| | | | | marks) |

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

1. A polypropylene resin composition comprising:
a) a random copolymer of propylene, at least one C₄-C₁₀ α-olefin, and ethylene, wherein the ratio of the weight percentage of ethylene in said polypropylene random copolymer relative to the sum of the weight percentages of the C₄-C₁₀ α-olefins is less than or equal to 1; and,
b) from about 10 to about 20,000 ppm of at least one nucleating agent.

2. The polypropylene resin composition of claim 1 wherein the quantity of nucleating agent is sufficient to provide a polypropylene resin composition having a melting point at least 3° C. higher than the melting point of the random copolymer of propylene without the nucleating agent.

3. The polypropylene resin composition of claim 1 where the random copolymer is made from a process comprising at least one polymerization stage.

4. The polypropylene resin composition of claim 1 where the random copolymer is made from a one-stage, gas phase polymerization process.

5. The polypropylene resin composition of claim 1 wherein the at least one nucleating agent comprises one or more of sodium benzoate, lithium benzoate, talc, metal salts of organic derivatives of phosphoric acid, dibenzylidene sorbitol or its derivatives, rosin or its derivatives, the di-sodium salt of norbornane dicarboxilic acid or its derivatives, an amide compound or a polymer capable of inducing a crystal nucleus in said random copolymer.

6. A film or film layer, made from the resin composition of claim 1, where the melting point, as determined by DSC from the film or film layer, is at least 1° C. higher than the melting point of a corresponding film or film layer made from the polymer strand or pellet of the corresponding resin composition without any nucleating agent.

7. The film or film layer of claim 6 where the SMS parameter is larger than the SMS parameter of a film made from a resin composition without a nucleating agent.

8. The film or film layer of claim 6 where the SMS parameter is larger than 24.1%, more preferably larger than 24.5% and most preferably larger than 25%.

9. A process for the production of the resin composition of claim 1, comprising
a) at least one polymerization stage where propylene, at least one non-propylene α-olefin and ethylene are contacted with a Ziegler/Natta catalyst;
b) at least one compounding stage where the nucleating agents are added.

10. The process for the production of the resin composition of claim 1, comprising
a) one polymerization stage where propylene, at least one non-propylene α-olefin and ethylene are contacted with a Ziegler/Natta catalyst;
b) one compounding stage where the nucleating agents are added.

11. The process of claim 10, where the polymerization is carried out in the gas phase.
